(19) United States
(12) Patent Application Publication
(10) Pub. No.: US 2003/0001899 A1
(43) Pub. Date: Jan. 2, 2003

(54) Semi-transparent handwriting recognition UI

(75) Inventors: Minna Partanen, Oulu (FI); Vesa Simila, Hauklpudas (FI)

Correspondence Address: COHEN, PONTANI, LIEBERMAN & PAVANE, 551 Fifth Avenue, Suite 1210, New York, NY, 10176, US

(73) Assignee: Nokia Corporation

(21) Appl. No.: 09/896,963

(22) Filed: Jun. 29, 2001

(51) Int. Cl. G09G 5/00

(52) U.S. Cl. 345/800

(57) ABSTRACT

A user interface of a handwriting recognition system intended for use in small electronic devices, such as PDAs, mobile Telephones and laptop computers. The user interface is a semi-transparent window that opens in response to a user-initiated manuscript input to any point on a touch-activated screen of a display of the electronic device. The semi-transparent window may be resized or moved, as desired by the user, and may be automatically sizable in response to the placement of the user's manuscript input on the touch-activated screen.

### BACKGROUND OF THE INVENTION

1. Field of the Invention

The present invention is related to the field of user interfaces for electronic input devices, and more particularly, and to a user touch-activated screen interface for a handwriting recognition system.

2. Description of the Related Art

As electronic devices, such as computers, mobile telephones, PDAs and the like have become more commonplace, users expect those electronic devices to become more versatile and easier to use. One manner in which manufacturers have attempted to meet that expectation is in the form of the user interface.

Manufacturers have upgraded the user interfaces of even the smallest of devices to include features such as color displays, and human-centered ergonomic improvements. One specific improvement is in providing interfaces that permit handwritten input, by way of handwriting recognition.

Many different systems exist for recognizing handwritten characters, and outputting text in response to manuscript input is taught. Examples of such systems are disclosed in PCT Patent document Nos. WO 96/00424 and WO 98/29791, and in U.S. Pat. No. 6,195,638. These systems, however, do not deal with the user interface for inputting the handwriting, but rather with how to decipher it once it is input.

A common and popular device which permits handwritten input is sold under the name PALM PILOT® by Palm, Inc. The PALM PILOT® includes a dedicated touch-activated portion of its video display for inputting handwritten characters in a handwriting recognition system known as GRAFFITI®. While it is helpful for the user to have a known place that is usable for handwritten input, the dedicated area has its drawbacks.

First, the dedicated area is of a fixed and immutable size. The user may need more, or less room at any given time, and a fixed-size dedicated area is not always the right size.

Second, the dedicated area may not be in the most useful place, as the user may prefer for it to be in a different place, for example, a left-handed user may prefer to move the area to a place more suitable for his input.

Third, the dedicated area takes up a constant amount of space on the display, even when not in use. Especially on small devices, such as a PDA, losing a significant area of a user's screen for a manuscript input area when she is not using that input is bothersome.

Another electronic device permitting manuscript input to a dedicated area established for handwriting is disclosed in U.S. Pat. No. 5,049,862. This device, as well, however, does not address the drawbacks listed above.

There is thus a need for a user interface for providing a more flexible user input for manuscript input to an electronic device.

### SUMMARY OF THE INVENTION

It is an object of the present invention to provide a method and system for a user interface for an electronic device that is more adaptable and useful than known systems.

It is a further object of the invention to provide a method and system for providing a user interface for a handwriting recognition system for an electronic device in which the user inputs handwritten characters into a semi-transparent window which appears on a video display for such electronic device in response to the user moving a stylus across a touch-activated screen of the video display.

It is a still further object of the invention to provide a semi-transparent window for a user interface in a handwriting recognition system in which the semi-transparent window may be moved and sized depending upon the particular needs and preferences of the user.

The present invention is a method and system for a user interface of a handwriting recognition system intended for use in small electronic devices, such as PDAs, mobile telephones and laptop computers. However, the present invention may be used with a device of any size, including a desk-top computer, a mainframe computer, or even a consumer appliance such as a microwave oven. The user interface is a semi-transparent window that opens in response to a user-initiated manuscript input to any point on a touch-activated screen of a display of or associated with the electronic device. The touch-screen need not be a part of the device, as is the case with a PDA, mobile phone and laptop computer, but may also be merely connected, electronically or wirelessly, to the electronic device, as is the case with a desk-top computer. The semi-transparent window may be sized or moved, as desired by the user, and may be automatically sizable in response to the placement of the user's manuscript input on the touch-activated screen.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 of the drawings is a screen shot of the semi-transparent window of the present invention in operation;

FIG. 2 is a schematic representation of the components of the invention; and

FIG. 3 is a flow chart showing the logical operation of the invention.

### DETAILED DESCRIPTION OF THE PRESENTLY PREFERRED EMBODIMENTS

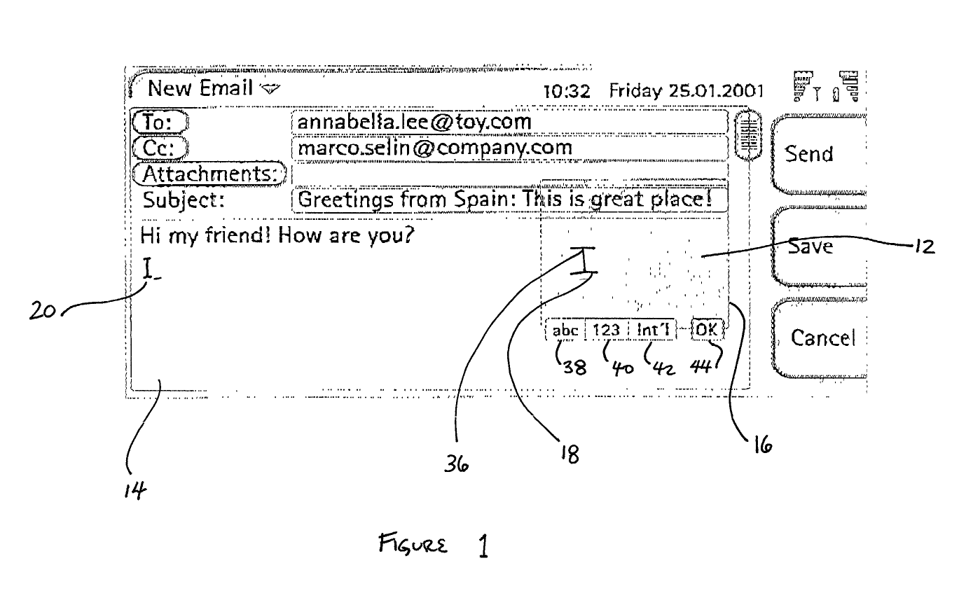

FIG. 1 depicts a video display 10, in accordance with the present invention. Display 10 includes a semi-transparent window 12 overlying a video display screen 14 which is preferably touch-activated. Semi-transparent window 12 is defined by boundaries 16, and is distinguished from the surrounding area of video display screen 14, for example, by boundary lines, or by being of a different color or brightness. The color and brightness of semitransparent window 12 are selected so that the features of the underlying video display screen 14 are still visible, thereby permitting the user to see what lies beneath semi-transparent window 12 yet still permitting the user also to see the contents of the overlying semitransparent window 12. The user may input a manuscript character 18, for example, the letter “I”, and that character will be recognized by handwriting recognition software in known fashion and output as the character “I” 20 on display 14 in the position allotted therefor.

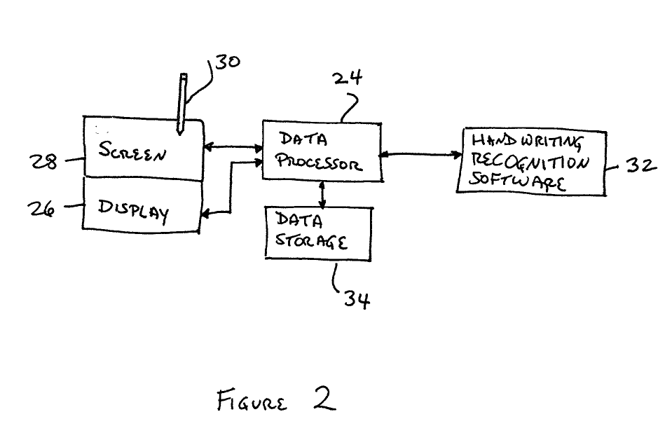

FIG. 2 shows a schematic representation of the components of the preferred embodiment of the inventive system 22. Some form of data processor 24, such as that within a PDA, a mobile phone, computer or other electronic device, is coupled to a display 26, which includes a screen 28. Screen 28 is adapted to receive information from a user by being activated by an external input device 30. In the preferred embodiment, this activation may be by way of screen 28 being activated by touch, for example, by a stylus 30. Although stylus 30 may be a device specially made for the particular touch-activated screen 28, it may also be any form of writing implement to input handwritten data, such as letters or numbers, to touch-activated screen 28. Where screen 28 is not touch-activated, input may be implemented by a mouse, trackball, joystick, electronic tablet or any other form of input device. In response to the movement of input device 30 on screen 28, screen 28 sends a signal to data processor 24 describing the movement of input device 30.

Data processor 24 generates a display signal for displaying on display 26 the handwriting as it is generated, so that the user has some feedback on what is being written. This display will stay on display 26 for a predetermined period of time, or until the user begins to write another character. In this fashion, the user is able to keep track of what he or she has written.

The pattern of the handwritten character is relayed to handwriting recognition software 30 (which may be stored in data processor 24). Handwriting recognition software 30 analyzes the user's manuscript input, and then generates a signal to data processor 24 identifying the manuscript characters as specific letters or numbers. These characters are then relayed to display 26 for display to the user.

Data processor 24 is also coupled to a data storage area 34, which may also be a part of the data processor's memory, for storing user preferences and other data.

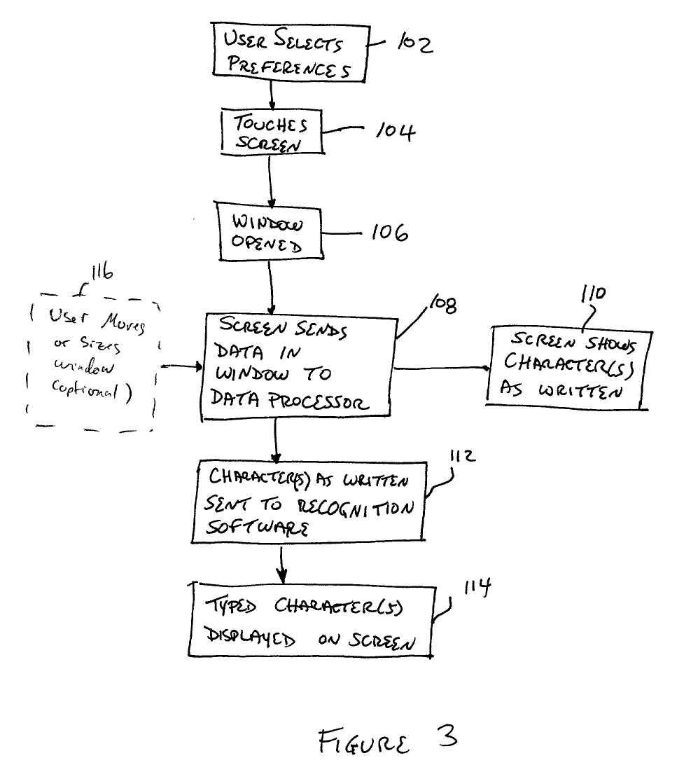

Referring to FIG. 3, before commencing use of the system, a user must establish certain preferences, step 102, or accept the default preferences of the system. For example, the user must select the manner in which semi-transparent window 12 is rendered distinct from the background of video display screen 14. This may be accomplished by selecting a translucent coloring for semi-transparent screen 12, by selecting a different brightness therefor, etc. Other modes of differentiation may be established as well, and the user must select which mode is to be used, although system defaults may require the use of a specific format, according to the features of the display, to provide the user with the optimal mode for differentiation between the appearances of semi-transparent window 12 and the remainder of video display screen 14.

Another preference to be established is the size and position of semi-transparent window 12 upon its initial presentation on display 26. For most languages, including English, the screen might open so that the open area of semi-transparent window 12 is to the right of the opening point. For other languages which are written right to left, the opening might be on the opposite side of the opening point, to make it easier for the user to write in accustomed format.

Semi-transparent window 12 also must be positioned vertically with respect to the opening point, and it is preferred that the position of semi-transparent window 12 relative to the opening touching of the input device 30 to screen 28 be selected so that the natural movement of the user in writing the desired manuscript character will be in the direction of the middle of semi-transparent window 12. Default orientations may be established depending upon the language of the user, whether the user is right- or left-handed, the requirements of the particular handwriting recognition software, etc.

Once these preferences are established, the user may begin use of the inventive system in the normal course of his or her practice.

In addition, the system may be set up so that any one or more of the pre-selected preferences may be changed after semi-transparent window 12 has been opened. This feature might be desirable, for example, if printed text displayed on the screen interferes more than desired with the pre-selected location of semi-transparent window 12. Semi-transparent window 12 may be moved or resized in a way similar to that used in various known programs. For example, to resize semi-transparent window 12, the user might touch stylus 30 to a portion of the edge of semi-transparent window 12 and drag this edge in the desired direction, thereby increasing or decreasing the size of semi-transparent window 12. To move semi-transparent window 12, the user may touch with stylus 30 a particular place on semi-transparent window 12 and drag the entire semi-transparent window 12 to a new position.

To initiate the opening of the user interface, the user may simply contact touch-activated screen 28, step 104, at any desired location (for example at point 36 shown in FIG. 1 where writing by the user begins). The initial contact of stylus 30 to screen 28 causes screen 28 to generate a signal to data processor 24, which then accesses the preferences established for opening semi-transparent window 12, and uses those preferences to generate, step 106, semi-transparent window 12 on display 14. The user continues to write the manuscript character(s) in semi-transparent window 12, while screen 14 sends the output, step 108, showing the movement of stylus 30 thereon to data processor 24 which generates an output showing the handwritten input, step 110, as it is written, and simultaneously sends the pattern of the manuscript character to the handwriting recognition software 32, step 112.

The display will stay active as determined by system preferences, for example, while the user is writing a single block of text, such as a single character, or word. As each new block of text is commenced and, identified, for example, by lifting stylus 30 from touch-activated screen 28, the prior display may be cleared.

Alternatively, the preferences may be established so that the displayed character 18 remains displayed for a predetermined period of time, e.g., 2 seconds, after the last input from input device 30 to video display screen 26.

Once the pattern is completed, handwriting recognition software 32 determines the intended character, and sends it, step 114, through data processor 24 to be presented on display 26 (see letter 20 in FIG. 1).

In this fashion, system 10 conveniently and efficiently generates typed characters in response to manually generated character input.

If the user wishes, he may move or size semi-transparent window 12, step 116.

The display window 12 may provide for switching between capital letters and small letters, numbers or an international character set, for example, by touching with the stylus 30 the virtual buttons 38, 40 and 42 of semi-transparent window 12. Semi-transparent window 12 may also provide for the display of a virtual keyboard having letter keys and/or number keys which would allow the user to select particular letters and/or numbers by touching the keys with the stylus. Preferably, such a virtual keyboard would be semitransparent to allow viewing of content under the window.

Semi-transparent window 12 may also have a virtual button 44 which when activated will cause semi-transparent window 12 to de-activate and disappear completely.

As a further option, certain software may provide for the automatic opening of semi-transparent window 12 as a prompt to the user for input to respond to a specific data entry field, for example, as a response to an e-mail, as shown in FIG. 1, or in response to an internet web site which requires the entry of information or the completion of a form.

Thus, while there have shown and described and pointed out fundamental novel features of the invention as applied to preferred embodiments thereof, it will be understood that various omissions and substitutions and changes in the form and details of the methods and devices described and illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A user interface for a handwriting recognition system used with a visual display having a screen, said interface comprising:
means for opening a semi-transparent window in said display, said semi-transparent window permitting a user to view features of a portion of said display over which said semitransparent window is opened, said semi-transparent window having boundaries which define a contrasting area on said display.

2. The user interface of claim 1, further comprising:
an input device for inputting data from said user;
and wherein said semi-transparent window is opened automatically when said user activates said input device at a point on said screen.

3. The user interface of claim 2, wherein said semi-transparent window opens in a predetermined size and position relative to said point on said screen.

4. The user interface of claim 3, further comprising means for permitting said user to alter said size of said semi-transparent window after said semi-transparent window opens.

5. The user interface of claim 4, further comprising means for automatically increasing said size of said semi-transparent window when said user touches said touch-activated screen at a point on said touch-activated screen which is outside said borders of said semi-transparent window after said semi-transparent window has been opened, said increased size of said semi-transparent window including said point on said touch-activated screen which is outside said borders.

6. The user interface of claim 3, further comprising means for permitting said user to move said semi-transparent window to a new position in said display from said predetermined position after said semi-transparent window has been opened.

7. The user interface of claim 3, wherein said predetermined size and position are alterable by said user.

8. The user interface of claim 1, wherein said contrasting area is of a color which is different from a color of said portion of said display over which said semi-transparent window is opened.

9. The user interface of claim 1, wherein said contrasting area is of a brightness which is different from a brightness of said portion of said display over which said semitransparent window is opened.

10. The user interface of claim 2, wherein said opened semi-transparent window closes automatically upon an elapse of a predetermined time interval during which no input by said user occurs.

11. The user interface of claim 1, wherein said semi-transparent window opens automatically when said device requires entry of information from said user.

12. The user interface of claim 2, further comprising means for generating a visual representation on said display of movement of said input device implement by said user across said screen.

13. The user interface of claim 12, in which said means for generating stops generating said visual representation of said movement of said writing implement across said display when a predetermined period of time elapses after cessation of movement of said input device on said display.

14. The user interface of claim 2, wherein said input device is selected from the group consisting of: a touch-activated screen, a mouse, a joystick, a keyboard, a trackball and an electronic tablet.

15. A user input system for use with an electronic device, comprising:
an input device;
a visual display having a screen, said screen including means for generating an output signal in response to a signal generated by said input device;
means for opening a semi-transparent window in said display in response to said signal from said input device, said semi-transparent window permitting a user to view features of a portion of said display over which said semi-transparent window is opened, said semi-transparent window having boundaries which define a contrasting area on said display and being sized to receive input from said input device, said input including at least one manuscript character;
means for recognizing said at least one received manuscript character; and
means for displaying said at least one recognized manuscript character on said visual display.

16. The user input system of claim 15, wherein said semi-transparent window is opened automatically in response to said input from said input device.

17. The user input system of claim 16, wherein said semi-transparent window opens in a predetermined size and position relative to a point at which said at least one manuscript character is input.

18. The user input system of claim 17, further comprising means for permitting said user to alter said size of said semi-transparent window after said semi-transparent window is opened.

19. The user input system of claim 18, further comprising means for automatically increasing said size of said open semi-transparent window when said at least one manuscript character is input at a point on said screen which is outside said borders of said semitransparent window after said semi-transparent window has been opened, said increased size of said semi-transparent window including said point which is outside said borders.

20. The user input system of claim 17, further comprising means for permitting said user to move said semi-transparent window to a new point in said display from said predetermined position after said semi-transparent window has been opened.

21. The user input system of claim 17, wherein said predetermined size and position are alterable by said user.

22. The user input system of claim 15, wherein said contrasting area is of a color which is different from a color of said portion of said display over which said semi-transparent window is opened.

23. The user input system of claim 15, wherein said contrasting area is of a brightness which is different from a brightness of said portion of said display over which said semi-transparent window is opened.

24. The user input system of claim 15, wherein said open semi-transparent window closes automatically upon elapse of a predetermined time interval during which no touching of said touch-activated screen occurs.

25. The user input system of claim 15, wherein said semi-transparent window opens automatically when said device requires entry of information from said user.

26. The user input system of claim 15, further comprising means for generating a visual representation on said display of movement of said input device by said user across said screen.

27. The user input system of claim 26, in which said means for generating stops generating said visual representation of said movement of said input device across said screen when a predetermined period of time elapses after any movement of said input device.

28. The user input system of claim 15, wherein said electronic device is a telephone.

29. The user input system of claim 15, wherein said electronic device is a computer.

30. The user input system of claim 15, wherein said electronic device is a personal digital assistant.

31. The user input system of claim 15, wherein said input device is selected from the group consisting of: a touch-activated screen, a mouse, a joystick, a keyboard, or trackball, and an electronic tablet.

32. In a handwriting recognition system used with a visual display having a screen, a method of providing a user interface, said method comprising:
opening a semi-transparent window in said display, said semi-transparent window permitting a user to view features of a portion of said display over which said semi-transparent window has opened, said semi-transparent window having boundaries which define a contrasting area on said display.

33. The method of claim 32, wherein said semi-transparent window is opened automatically when said user activates an input device for translating movement of said input device into a graphical representation of said movement on said screen.

34. The method of claim 33, wherein said semi-transparent window opens in a predetermined size and position relative to a point on said screen at which said user initiates movement of said input device.

35. The method of claim 32, further comprising means for permitting said user to alter said size of said semi-transparent window after said semi-transparent window has opened.

36. The method of claim 35, further comprising the step of:
automatically increasing said size of said open semi-transparent window when said user activates said input device at a point on said display which is outside said borders of said semitransparent window after said semi-transparent window has been opened.

37. The method of claim 34, further comprising the step of:
permitting said user to move said semi-transparent window to a new position in said display from said predetermined position after said semi-transparent window has opened.

38. The method of claim 34, wherein said predetermined size and position are alterable by said user.

39. The method of claim 32, wherein said contrasting area is of a color which is different from a color of said portion of said display over which said semi-transparent window has opened.

40. The method of claim 32, wherein said contrasting area is of a brightness which is different from a brightness of said portion of said display over which said semi-transparent window has opened.

41. The method of claim 32, wherein said open semi-transparent window closes automatically upon elapse of a predetermined time interval during which no input from said input device occurs.

42. The method of claim 32, further comprising the step of:
opening said semi-transparent window automatically when said device requires entry of information from said user.

43. The method of claim 32, further comprising the step of:
generating a visual representation on said display of movement of said input device by said user.

44. The method of claim 43, further comprising the step of:
ceasing generating said visual representation of said movement of said input device when a predetermined period of time elapses after any movement of said input device.

45. The method of claim 32, wherein said input device is selected from the group consisting of: a touch-activated screen, a mouse, a joystick, a keyboard, a trackball, and an electronic tablet.

46. A method of inputting data to an electronic device, comprising:
displaying information on a visual display having a screen;
generating an output signal in response to movement of an input device;
opening a semi-transparent window in said display in response to said movement of said input device, said semi-transparent window permitting a user to view features of a portion of said display over which said semi-transparent window is open, said semi-transparent window having boundaries which define a contrasting area on said display and being sized to receive an input from said input device, said input including at least one manuscript character;
recognizing said at least one manuscript character; and
displaying the recognized manuscript characters on the visual display.

47. The method of claim 46, further comprising the step of:
opening said semi-transparent window automatically when said user moves said input device.

48. The method of claim 46, wherein said semi-transparent window opens in a predetermined size and position relative to a point on said display at which said user commences movement of said input device.

49. The method of claim 46, further comprising the step of:
permitting said user to alter said size of said open semi-transparent window after said semi-transparent window opens.

50. The method of claim 49, further comprising the step of:
automatically increasing said size of said open semi-transparent window when said user touches said touch-activated screen at a point on said display which is outside said borders of said semi-transparent window after said semi-transparent window has been opened.

51. The method of claim 48, further comprising the step of:
permitting said user to move said semi-transparent window to a new position on said display from said predetermined position after said semi-transparent window has opened.

52. The method of claim 48, wherein said predetermined size and position are alterable by said user.

53. The method of claim 46, wherein said contrasting area is of a color which is different from a color of said portion of said display over which said semi-transparent window has opened.

54. The method of claim 46, wherein said contrasting area is of a brightness which is different from a brightness of said portion of said display over which said semi-transparent window has opened.

55. The method of claim 46, further comprising the step of closing said open semitransparent window automatically upon elapse of a predetermined time interval during which no touching of said touch-activated screen occurs.

56. The method of claim 46, further comprising the step of:
opening said semi-transparent window automatically when said device requires entry of information.

57. The method of claim 46, further comprising the step of:
generating a visual representation on said display of movement of said input device.

58. The method of claim 57, further comprising the step of:
ceasing generating of said visual representation of said movement of said input device when a predetermined period of time elapses after any movement of said input device.

59. The method of claim 46, wherein said electronic device is a telephone.

60. The method of claim 46, wherein said electronic device is a computer.

61. The method of claim 46, wherein said electronic device is a personal digital assistant.

62. The method on claim 46, wherein said input device is selected from the group consisting of: a touch-activated screen, a mouse, a joystick, a keyboard, a trackball, and an electronic tablet.
